(19) United States
(12) Patent Application Publication
(10) Pub. No.: US 2020/0293261 A1
(43) Pub. Date: Sep. 17, 2020

(54) User Interaction with Shared Content During a Virtual Meeting

(71) Applicant: MICROSOFT TECHNOLOGY LICENSING, LLC, Redmond, WA (US)

(72) Inventors: Raghav JANAMANCHI, Bellevue, WA (US); Vaijanta Vithal CHAURE, Bellevue, WA (US)

(73) Assignee: MICROSOFT TECHNOLOGY LICENSING, LLC, Redmond, WA (US)

(21) Appl. No.: 16/355,202

(22) Filed: Mar. 15, 2019

(51) Int. Cl. G06F 3/14; H04L 12/18; G06F 16/176

(52) U.S. Cl. CPC G06F 3/1454; G06F 16/176; H04L 12/1831; H04L 12/1822

(57) ABSTRACT

A method of and system for enabling interactions with a document being presented during a virtual meeting is carried out by making a copy of the document available to meeting attendees for restricted use. The method may include receiving a request from a server to initiate presentation of a document being presented by a presenter client device during a virtual meeting, displaying the document at a participant client device, enabling a meeting participant using the device to interact with the document during the virtual meeting by moving to a first portion of the document different from a second portion being currently presented by the presenter client device during the virtual meeting, receiving a request at the participant client device to synchronize with the presentation being presented by the presenter client device, invoking a synchronization signal for synchronizing with the presentation, and displaying the second portion of the document being presented by the presenter client device.

### TECHNICAL FIELD

This disclosure relates generally to interactions with shared content in a virtual meeting and, more particularly, to enabling a meeting participant to interact with content shared by a presenter during a virtual meeting.

### BACKGROUND

In recent years, there has been a significant increase in the use of virtual meeting applications to conduct meetings. This may be because more and more people work from home or collaborate with colleagues or other people remotely from different locations. The use of these applications enables participant to hear and/or view each other and as such freely exchange ideas and information without the need to be in the same room, thus greatly reducing the cost and time associated with conducting in-person meetings.

As part of conducting a meeting, one or more participants may desire to present information or documents to the other participants in the group. During in-person meetings, this may be done by handing out print-outs to each participant or presenting a document via an electronic device that displays the content on a screen in the room. In a virtual meeting, this may occur by enabling one or more participants to share content with the other participants. This is generally done by displaying the shared content on each participants' display screen. In such cases, control of the shared content remains with the presenter who can move through the document to, for example, show various portions. This limits the ability of the participants to review the shared content at their own pace and based on their individual needs.

Hence, there is a need for an improved method and system for enabling user interactions with presented content during a virtual meeting.

### SUMMARY

In one general aspect, the instant application describes a device having a processor and a memory in communication with the processor where the memory stores executable instructions that, when executed by the processor, cause the device to perform multiple functions. The function may include receiving a request from a server to initiate presentation of a document being presented by a presenter client device during a virtual meeting, displaying the document at a participant client device, enabling a meeting participant using the device to interact with the document during the virtual meeting by moving to a first portion of the document different from a second portion being currently presented by the presenter client device during the virtual meeting, receiving a request at the participant client device to synchronize with the presentation being presented by the presenter client device, invoking a synchronization signal for synchronizing with the presentation, and displaying the second portion of the document being presented by the presenter client device.

In yet another general aspect, the instant application describes a method for enabling interactions with a document being presented during a virtual meeting where the method includes the steps of receiving a request from a server to initiate presentation of a document being presented by a presenter client device during a virtual meeting, displaying the document at a participant client device, enabling a meeting participant using the device to interact with the document during the virtual meeting by moving to a first portion of the document different from a second portion being currently presented by the presenter client device during the virtual meeting, receiving a request at the participant client device to synchronize with the presentation being presented by the presenter client device, invoking a synchronization signal for synchronizing with the presentation, and displaying the second portion of the document being presented by the presenter client device.

In a further general aspect, the instant application describes a non-transitory computer readable medium on which are stored instructions that when executed cause a programmable device to receive a request from a server to initiate presentation of a document being presented by a presenter client device during a virtual meeting, display the document at a participant client device, enabling a meeting participant using the device to interact with the document during the virtual meeting by moving to a first portion of the document different from a second portion being currently presented by the presenter client device during the virtual meeting, receive a request at the participant client device to synchronize with the presentation being presented by the presenter client device, invoke a synchronization signal for synchronizing with the presentation, and display the second portion of the document being presented by the presenter client device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 depicts an example user interface for sharing content in a virtual meeting application.

FIGS. 3A-3B depict various example user interfaces for enabling interaction with shared content in a virtual meeting application according to implementations of the present invention.

FIG. 3C-3D depict alternative interactions with shared content available to a participant during a virtual meeting.

FIGS. 4A-4B depict side by side views of example view panes displayed on a presenter's screen and a participant's screen.

FIG. 4C depicts a virtual meeting user interface displaying a presenter's view pane alongside a participant's view pane.

FIG. 5A is a flow diagram showing an example method performed by a presenter client device for enabling interactions with shared content during a virtual meeting.

FIGS. 5B-5C are flow diagrams showing an example method performed by a participant client device for enabling interactions with shared content during a virtual meeting.

FIG. 6 is a block diagram illustrating an example software architecture, various portions of which may be used in conjunction with various hardware architectures herein described.

FIG. 7 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

One limitation of existing virtual meeting software applications is that participants do not have an ability to interact with a document that is being presented by a presenter during the meeting. In general, when a meeting attendee decides to present some information to the other participants during a virtual meeting, a view of his/her screen is shared with the other participants. The presenter may then have sole control over how the information is presented. For example, if the presenter chooses to present information within a Microsoft Word® document, he/she may open the document and move through the pages. The other participant or participants may have the ability to view the shared screen as the presenter moves through the document. However, they may not be able to interact with the document individually. This limits the ability of the participants to make use of the information at their own pace and based on their individual needs. For example, a participant desiring to move back to a previous page to more carefully review a portion will not have the opportunity to do so.

Currently, the only way individual participants can interact with a document being presented is if the presenter chooses to share the document with them directly. This may be done via the virtual meeting application by, for example, enabling each participant to download the document to their electronic device or by using a separate method of sharing the document, such as email. In either case, the presenter would need to agree to share the document with the other participants, which may not always be the case. For example, the presenter may not desire to allow the participants to have a copy of the document for confidential or privacy reasons, or because the document is a work-in-progress and is not yet available for release. Moreover, even if the presenter agrees to share the document, making the request to the presenter, taking steps to share it and then to download it may take valuable time away from the meeting and cause distraction. Thus, there is a need in the art for a method and system of enabling meeting participants to interact with documents asynchronously during a virtual meeting without downloading it to their computing device.

To address these issues and more, in an example, this description provides technology implemented for an improved method and system of enabling a meeting participant to interact asynchronously with content shared by a presenter during a virtual meeting. To improve the current methods of presenting information in a meeting, the improved system and method may enable the presenter to share a copy of a document being presented during the virtual meeting, with each participant's virtual meeting application or may provide direct access to it via an online virtual meeting service. To achieve this, the presenter's device may send a copy of the document to a server, which may in turn, make the copy available to each participant. This may be done by the server storing a copy in a data store, encrypting the document and sending a copy to each participant's device. Thus, participant devices utilizing the virtual meeting application may receive an encrypted copy of the document via their virtual meeting application. Alternatively, participant devices that utilize a web version of the virtual meeting application, may be provided access the document via an online virtual meeting service. Having direct limited access to the document may enable each participant to view and interact with the document asynchronously during the meeting, while preventing the user to have access to the document outside of the meeting. To further improve the participants' experience during the meeting, the presenter device may transmit updated screen data to the server which may in turn forwarding the data to participant devices, as the presenter interacts with the document (e.g., moves to the next page or makes changes to the document) to enable synching each participant's view with the presenter's view when needed. This may be done, for example, by the server forwarding the latest screen data or the data indicating differences between the last time a participant was viewing the presenter's screen and the current view to the participant's devices such that when a participant finishes interacting with the document, they may return back to the presenter's screen (e.g., the location of the document the presenter is in at the moment).

Furthermore, each participant may be able to perform asynchronous operations on the document. For example, participants may have limited or full editing capabilities (e.g., highlight or underline a portion or insert a comment in the document) via the virtual meeting application, in which case, an updated copy of the document may be sent from the participant making the changes to the server. In such an event, the other participants in the meeting may receive the updated portion to replace the previous version. This may enable a participant to bring attention to a particular portion or a ask a question without interrupting the presenter. As a result, the solution provides an improved user experience for attendees of a virtual meeting in an efficient and secure manner.

As will be understood by persons of skill in the art upon reading this disclosure, benefits and advantages provided by such implementations can include, but are not limited to, a solution to the technical problems of participants not being able to interact asynchronously with a document that is being presented during a virtual meeting. Technical solutions and implementations provided here optimize and improve the process of presenting a document during a virtual meeting. The benefits provided by these solutions include improving user experience in a timely and efficient manner.

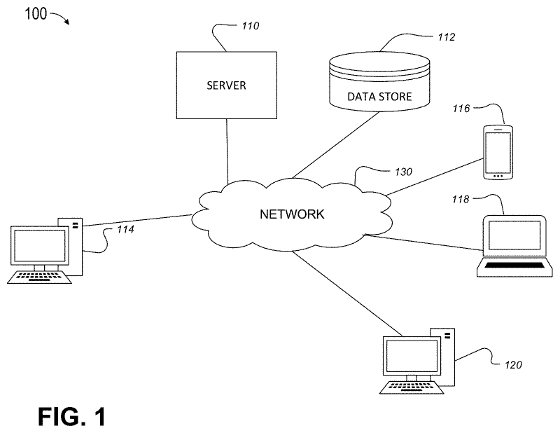

FIG. 1 illustrates an example system 100, upon which aspects of this disclosure may be implemented. The system 100 may include a sever 110 which may be connected to or include a data store 112 in which data relating to virtual meetings may be stored. The server 110 may be responsible for managing communications between various devices during virtual meetings. For example, the server 110 may run an application, stored for example in the data store 112, that enables virtual meetings between various participant devices. To achieve that, signals may be sent to and received from the server from one or more of the meeting participants. The signals may be audio, video or other data signals. For example, each of the client devices may send audio signals to the server, which may turn in transmit those signals to other devices in the virtual meeting to enable the participants to engage in a voice conversation. Video signals may be sent and received from various devices during video-enabled virtual meetings to enable participants to see each other. Data signals may be transmitted to enable one or more participants to view a presenter's screen. Data signals may include data files that may be sent by a presenter and received by the other participants in the meeting to enable the participants to interact with a document being presented. In one implementation, the server may provide a cloud-based virtual meeting service.

The system 100 may also include a presenter client device 114 and multiple participant client devices 116, 118 and 120, each of which are connected via a network 130 to the server 110. Each of the client devices 112, 116, 118 and 120 may include or have access to a virtual meeting application which enables users of each device to participate in virtual meetings. It should be noted, that although client device 114 is labeled as a presenter device and client devices 116, 118 and 120 are labeled as participant devices, each of the client devices 112, 116, 118 and 120 may become a presenter during a virtual meeting. The presenter client device may be the host of the virtual meeting or any of the other participant devices.

The client devices 112, 116, 118 and 120 may be personal or handheld computing devices having or being connected to both input and output elements. For example, the client devices 112, 116, 118 and 120 may be one of: a mobile telephone; a smart phone; a tablet; a phablet; a smart watch; a wearable computer; a personal computer; a desktop computer; a laptop computer; a gaming device/computer; a television; and the like. This list is for example purposes only and should not be considered as limiting. The network 110 may be a wired or wireless network(s) or a combination of wired and wireless networks that connect one or more elements of the system 100.

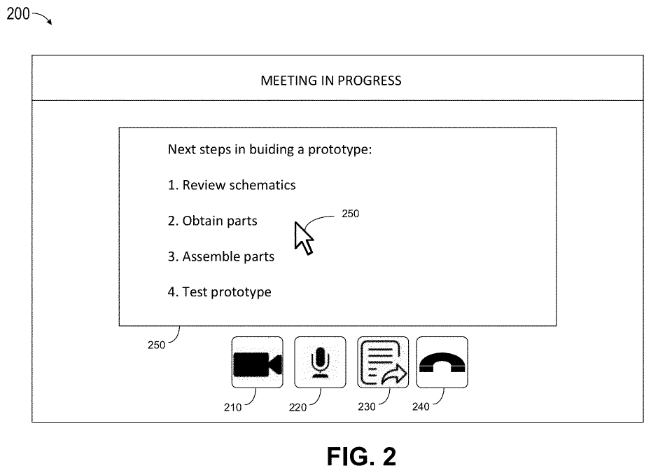

FIG. 2 illustrates an example user interface (UI) screen 200 which may be presented to a meeting attendee during a virtual meeting in which a document is being presented by one of the participants. The UI screen 200 may be shown on any of the client devices participating in the virtual meeting. In one implementation, the UI screen 200 is displayed by the virtual meeting application running on a meeting attendee's client device. Alternatively, the UI screen 200 may be displayed by an online virtual meeting service. The UI screen 200 may include a button 210 to enable/disable video signals to be transmitted from the client device displaying the screen 200. This may be done, for example, to enable a video conference. The same button 210 may be used to enable and disable transmission of video signals. Similarly, a button 220 may be used to enable/disable transmission of audio signals during the meeting. Button 220 may be used for example to mute a microphone of the client device, when the participant does not desire to share audio signals from his/her environment with the meeting participants. When the participant is ready to speak, he/she may press the button 220 to unmute the device and enable transmission of audio signals.

The UI screen 200 may also include a start presentation button 230 which may enable the user to begin sharing a portion of his/her screen, a document to which the presenter has access to, or any other sharable information. In one implementation, upon pressing the presentation button 230, a menu may be presented to the user to enable selection of portion(s) of the screen the user wishes to share with the other participants. For example, the user may have the option of selecting to share one or more portions of any of the user's screens (e.g., when the user has access to multiple display devices and/or virtual display areas or virtual desktops), or a file (e.g. a document stored on the user's device or in a cloud storage device to which the user has access from the user's device). The user may also have the ability to choose to share only portions of the screen displaying a particular application, such as Microsoft Word®, Microsoft PowerPoint®, or any other Microsoft Office® application. The selection may be made for example via a pop-up menu.

When a user of the virtual meeting application and/or service chooses to share one or more portions of the screen, screen data of the user's screen may be transmitted to the server which may in turn transfer the data to the other participants. In this instant, the user may be able to open an application, open a document, play a video or perform any other operations that the user can normally perform on the user's device and transmission of screen data may enable the other meeting attendees to view the user's operations in real-time. Screen data may include image data, video data or any other type of data that enables capture, transmission and displaying of a copy of a user's screen. This may be achieved by utilizing a screen capture mechanism to capture and provide the screen data by any available means. For example, the presenter's device may use the screen capture mechanism to obtain an image of the screen or a representation of the screen in any type of form. A screen data processing mechanism may then be used by the presenter's device to process (e.g. convert, translate, etc.) the representation into screen data that is suitable for transmission. In one implementation, an application programming interface (API) (e.g. an operating system API) may be used to capture, process and/or provide the screen data. The screen data may represent the screen as tiles, thus providing a tile representation of the screen. In one implementation, the screen data may provide a pixel or bit-image representation of the screen. Any other suitable screen data may be captured and utilized by the presenter's client device and/or online service running on the presenter's client device.

When the user chooses to share a document, a pop-up menu may enable the user to browse to a location (e.g., on the user's device) at which the document is stored. By clicking on the document, the presenter may be able to open the document in the virtual meeting application in a pane such as pane 250 of UI screen 200. Consequently, the presenter may interact with the document (e.g., scroll through different portions of the document, highlight a portion, make edits to the document, add a new portion, and the like) and the other participants may be able to view the interactions in real-time. For example, the user may use the curser 250 to move to different portions of the document. As the user moves to the different portion, the participants' display may also move to the different portion. This may be done by utilizing a detecting mechanism to detect changes to the shared screen. The changes may include any user interface elements being added, removed, maximized, minimized and/or changing positions. For example, the detecting mechanism may detect if a new user interface element is being displayed. This may be done, by for example detecting if there is a change in the pixels in the image data. Once changes are detected, the presenter's device may capture, process and transmit updated screen data relating to the change to the server which may in turn transfer this data to the other participants such that the change can be replicated on the participant's screens.

This may allow the participants to see any changes to the presenter's screen in real-time, but it does not provide the capability for them to interact with the document. For example, if the presenter moves to a different part of the document, there is no way for the participants to move back to the previous portion other than asking the presenter to do so or requesting that the presenter sends them the document. This may cause distraction, disrupt the flow of the meeting, waste time and create an uncomfortable environment if the presenter is unable or unwilling to send a copy of the document to the requester. Technical solutions provided here address these issues by providing the participants restricted access to a presented document while the virtual meeting is taking place.

In addition to buttons 210, 220, and 230, the UI screen 200 may also include a disconnect button 240. The disconnect button 240 may be used during the meeting to end the user's participation in the meeting. This may occur at the end of the meeting or while the meeting is still ongoing. For example, if the user needs to leave early.

It should be noted that various other buttons and options may be available to users in different virtual meeting applications. However, currently available virtual meeting applications do not provide an option for a participant to interact with a document being presented without first downloading the document.

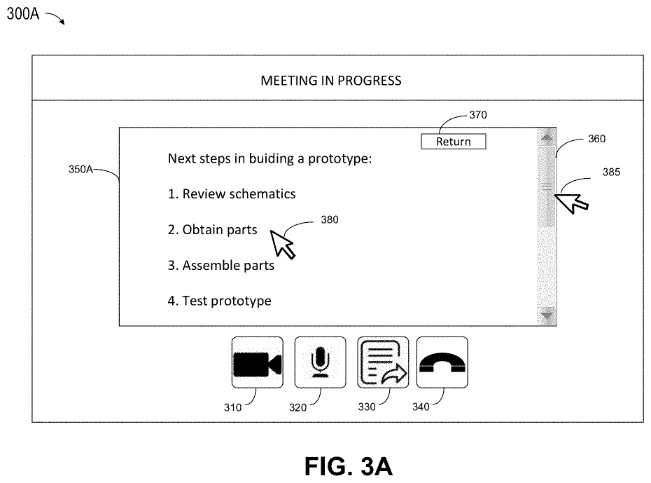

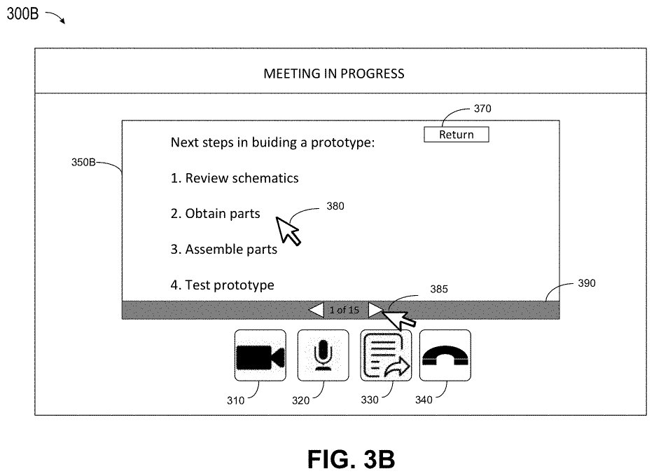

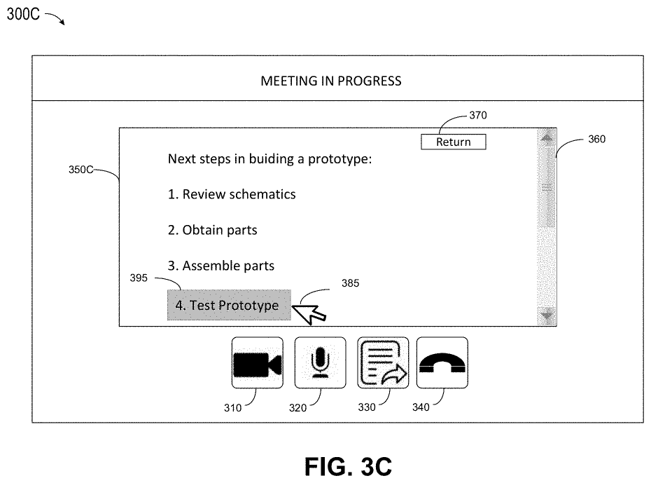

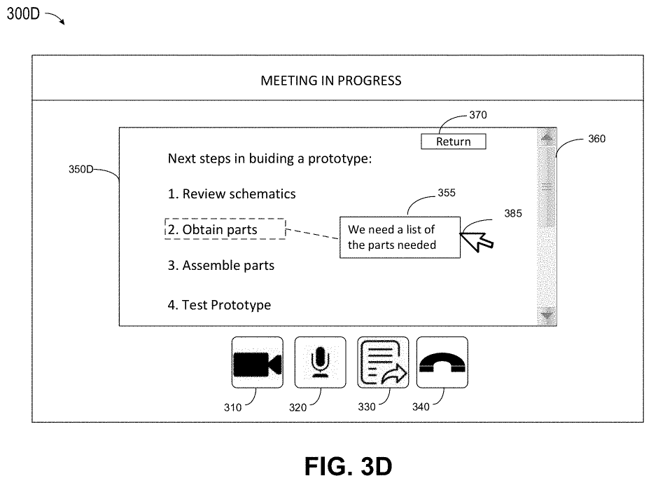

To address these issues and more, an improved example UI screen, such as the screen 300A depicted in FIG. 3A, may be presented to participants during a virtual meeting. Similar to the UI screen 200 of FIG. 2, the UI screen 300A may include a button 310 for enabling/disabling video transmissions, a button 320 for enabling/disabling audio signal transmissions, a button 330 for enabling presentation, and a button 340 for disconnecting from the meeting. The buttons 310, 320, 330, 340 may function similarly to those described above with respect to buttons 210, 220, 230 and 240 of FIG. 2 above. However, once a presenter chooses a document to present during the meeting, in addition to screen data being captured and transmitted from the presenter's device, a copy of the selected document may also be sent to the server. The copy may be transmitted to the other participants from the server via their virtual meeting applications or be made available to them via an online service. As a result, the pane 350A which displays a copy of the document being presented to the other participants may be scrollable via the scroll bar 360. This may enable participants other than the presenter to scroll to any portion of the document they wish to view or study further.

In one implementation, this may be done by a curser 385 which the participant may move as desired using input/output features available in their device. Thus, in addition to the curser 380 which displays the curser used by the presenter to move through or make changes to the document, each participant may make use of their own curser to move to different portions of the document. This may be achieved by using a layered windows technique to create and manage separate user interface elements within the virtual meeting application. For example, data relating to the presenter's curser position and activities with respect to the document may be transmitted by the presenter's device to the server which may in turn make use of or transfer the data to the participant's device, as appropriate. This data may be used to add a layer on top of the document in the participant's screen to show the presenter's curser movement and activities.

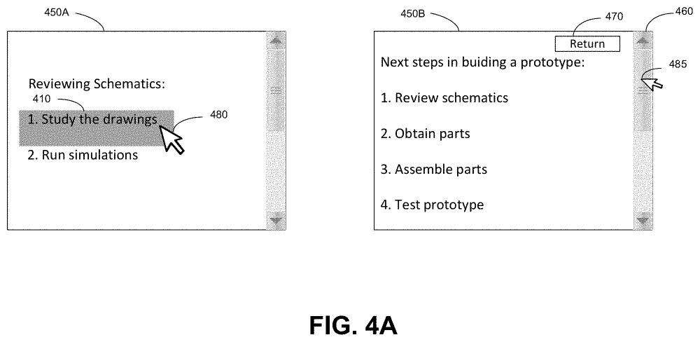

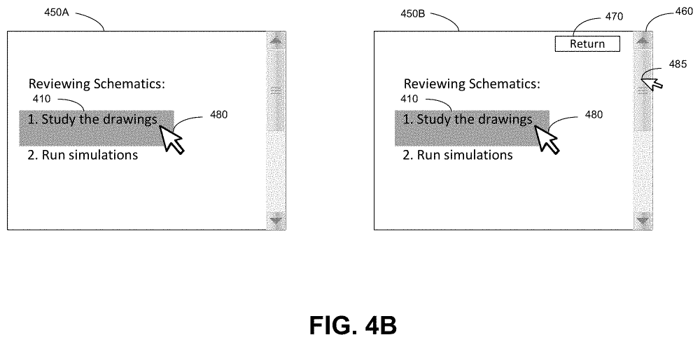

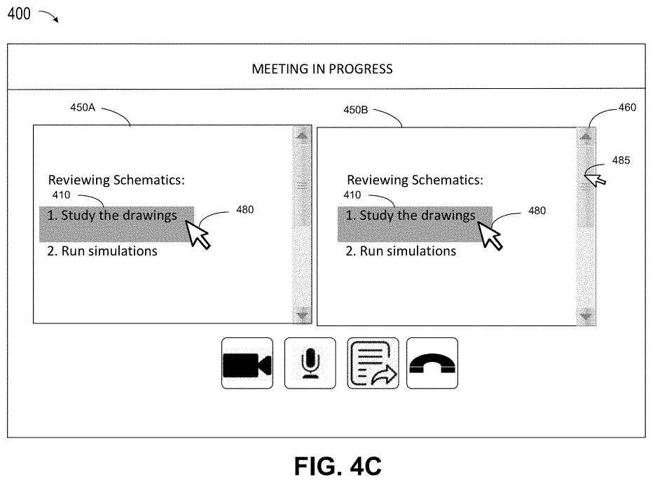

In one implementation, when the participant uses their device to move to a different page of the document than the one the presenter is currently on, they may not be able to view the presenter's current screen (e.g., the presenter's curser, or any changes made on the presenter's screen). For example, if the presenter highlights a portion of the document, the participant may not be able to see that immediately, if they are viewing a different portion of the document. In other words, once the participant starts interacting with the document (e.g., starts scrolling the pages of the document), the user interface may pause adding a layer on top of the document to show the presenter's curser movement and activities. This is illustrated in FIG. 4A which depicts side by side views of example view panes 450A on the presenter's screen and 450B on the participant's screen. As shown in pane 450B, the participant may decide to move to a previous page of the document by for example using the curser 485 to move the scroll bar 460. Alternatively, any other technique for interacting with the document may be utilized.

While the participant is reviewing the previous page, the presenter may interact with the current page (e.g., make changes to the document), move to a different page or section, or even open a new document. For example, the presenter may highlight a portion of the text such as text portion 410 on the current page using their curser 480. The participant may not be able to view any of these changes, as long as he/she is interacting asynchronously with the document. Instead, the participant may view the pages of the original document by moving through the document. While the participant is interacting asynchronously with the document, the presenter may continue sending updated screen data to the server. In one implementation, this updated data may continue being received by the participating device. The data may then be used at the participant device to compare it with the page the participant is currently on. If the participant happens to move to a page the presenter is currently on, the virtual meeting application of the participant device (or the server) may determine that the locations now coincide. In such a case, the participant's screen may display the presenter's pane (e.g., the presenter's curser movements and/or any changes the presenter may have made while the participant was interacting with the document) even if the participant is interacting asynchronously with the document.

Furthermore, updated screen data may continue to be transmitted by the presenter and received by the participant's device, such that when the participant is done exploring the document on their own, they may press a return button 470 to go back to the latest screen view being presented by the presenter (e.g. the page of the document the presenter is currently on). Once they do, they may be taken directly to the page the presenter is on. This is illustrated in FIG. 4B in which both view panes 450A on the presenter's screen and 450B on the participant's screen display the same information (e.g., the highlighted portion 410). To enable this feature, synchronization signals may be transmitted by the server and received by the participant device.

In one implementation, once the user of a participant device starts interacting with the document, a signal may be sent from the participant device to the server indicating that the user has begun exploring the document asynchronously. This may stop transmission of updated screen data to the participant. However, once the participant selects the return button 470, the participant device may send a signal to the server indicating their desire to go back to viewing the presenter's screen, at which point the server may transmit the latest updated screen data to the participant device. In one implementation, along with the signal indicating the participant's desire to synchronize their display with the presenter, the participant's device may also send screen data indicating the participant's latest screen information. This information may be compared with the latest screen data received from the presenter at the server and only data required to display the presenter's screen may be sent to the participant device. Alternatively, the server may transmit all the information to the participant's device and the process of comparison may occur at the participant device. In yet another alternative (e.g., for online virtual meeting services), the entire process may be performed by the sever.

In an alternative implementation, when the participant begins interacting with the document, a new pane may be opened in the UI screen of the virtual meeting application (or within the online virtual meeting page) that displays the document and the participant's interaction with it. This new pane may be displayed alongside the presenter pane such that the participant can view the presenter's screen at the same time as he/she is interacting with the document asynchronously. This is illustrated in FIG. 4C which depicts a virtual meeting user interface 400 displaying a presenter's view pane 450A alongside a participant's view pane 450B on the same screen. In this implementation, if the participant decides to stop interacting with the document and return to the presenter's screen, they may simply click on the presenter's view pane 450A to be taken back to a single view pane UI displaying the presenter's view pane 450A. In one implementation, instead of a split screen design where each of the presenter's view pane and participant's view pane are shown side by side, once the participant begins interacting with the document, the presenter's view pane may be changed into a minified window. The participant may then be able to return the minified window to its original size by clicking on it. To provide the split screen view, screen data signals from the presenter would continue to be transmitted to the server, where they are processed and/or sent to the participant to enable displaying the presenter's screen alongside an interactive participant view of the document.

In one implementation, if while the participant is exploring the document, the presenter closes the document, updated screen data indicating the closure may be transmitted from the presenter to the server and forwarded to the participant device such that the document is automatically closed on the participant's device. This may prevent a participant to view the document any longer than the presenter wishes them to. Alternatively, the participant may receive a notification that the presenter has closed the document but be given an opportunity to continue exploring the document for a period after it has closed. The period could be predetermined (e.g. set by the virtual meeting application) or changeable by the presenter. In one implementation, a participant interacting with the document may be allowed to continue their interactions for the entire duration of the meeting. In either case, however, once the meeting concludes or the participant gets disconnected from the meeting (e.g., they get disconnected from the network or they choose to leave the meeting), participant devices may receive an instruction to close and delete the document in order to prevent future access to the document.

FIG. 3B depicts an improved example UI screen 300B which may be presented to the participants during a virtual meeting illustrating a different type of document. Like the UI screen 300A of FIG. 3A, the UI screen 300B may include a button 310 for enabling/disabling video transmissions, a button 320 for enabling/disabling audio signal transmissions, a button 330 for enabling presentation, and button 340 for disconnecting from the meeting. However, the type of document selected by the presenter may be different than the one selected in screen 300A. For example, the type of document presented in FIG. 3A may have been a Microsoft Word or Microsoft Excel document having a vertical scroll bar, while the document presented in screen 300B may be a document similar to a Microsoft PowerPoint document which includes a horizontal scroll bar such as the scroll bar 390. The scroll bar 390 may enable the participants to user their curser 385 (or any other input/output means available to the participants) to move to a previous page or a next page. Like screen 300A, pane 350B of screen 300B may present a view of the document being presented that enables participant interactions, while displaying the presenter's screen which may include the presenter's curser 380. Similarly, a button 370 may be used to return to the presenter's screen when the participant wishes to.

FIG. 3B illustrates that the type of interactions with the documents available for participants may change depending on the type of document. As such, while any type of document shared by a presenter may be transmitted to the participants to enable individual interactions, the types of interactions available may change depending on the types of documents. In one implementation, a participant's virtual meeting application may interact with programs stored on the participant's device to enable the interactions based on the types of the documents. For example, local APIs may be used to provide the functionalities. Alternatively, the interactions may be enabled directly via the virtual meeting application and/or via the server. It should be noted that the techniques described herein may apply to any type of document.

FIG. 3C-3D depict alternative interactions that may be available to a meeting participant during a virtual meeting. FIG. 3C depicts an improved example UI screen 300C presented to participants of a virtual meeting during which a participant can manipulate certain portions of a presented document. For example, the presenter may utilize the curser 385 (or any other UI feature available on their device) to highlight a text portion 395 of the document. This is possible because the participant may have a local copy of the document with which the participant interacts. In addition to highlighting, the participant may have the ability to underline, and/or making any other changes to the font, paragraph or style of the document. This may be provided, for example, to enable the participant to bring attention to a particular portion. Other types of interactions are also contemplated. For example, in one implementation, the participant may be allowed to make changes to the text of the document. Those changes may be saved to the local copy only and as such deleted once the local copy is removed. This may allow the participant to return to the presenter's screen by pressing the return button 370, while retaining the participant's changes. In such an instant, if the presenter moves to the edited portion of the document, the participant's edits may be presented on the participant's display while the presenter's operations are also being shown. This may be achieved by utilizing patches for edited portions to the document data and refreshing those portions if they are being currently viewed.

FIG. 3C depicts an improved example UI screen 300D displayed to participants of a virtual meeting during which a participant can insert comments into a document being presented. This may be done, for example, by utilizing the curser 385 to select a portion of the document, before right clicking to display a context menu that provides an option for inserting a comment. Alternatively, a menu bar may be displayed as part of the pane 350D or on a separate portion of the screen 300D that provides the option for inserting a comment. Once the participant selects the option to insert a comment, a comment box such as the box 355 may be displayed on the screen 300D into which the user can insert comments.

It should be noted that changes made by each participant (e.g. those discussed with respect to FIGS. 3C-3D) may be asynchronous from operations performed by other participants. In this manner, each participant can have separate unique interactions with the document that do not affect each other. In one implementation, an option may be provided to propagate a change made by one participant to the other participant's and/or the presenter's copies. For example, a pop-up menu may be presented to the participant asking them if they would like the other participants to receive the change that they made. In such a situation, if the participant indicates a desire to share their changes, updated screen data may be transmitted from the participant to the server which may in turn forward the updated screen data to the other participants. In one implementation, the updated screen data may include metadata identifying the participant who made the change. This metadata may be displayed on other participant copies of the documents to identify the person who made the change. Alternatively, instead of sending updated screen data, the revised copy of the document may be sent and received by the server, which may in turn send the revised copy to all other meeting attendees with an instruction to change their copy with the revised copy. In one implementation, the server may compare the revised copy with the original copy stored in the data store and only send the revisions to the other participants with instructions to replace the revised parts of the document. In one implementation, this procedure may apply to changes made by the presenter. For example, if the presenter highlights a text portion, a revised copy of the document may be sent to the server which may then transmit the revised copy or the latest changes to the participant devices such that the documents displayed on each presenter's screen contain the latest changes made by the presenter.

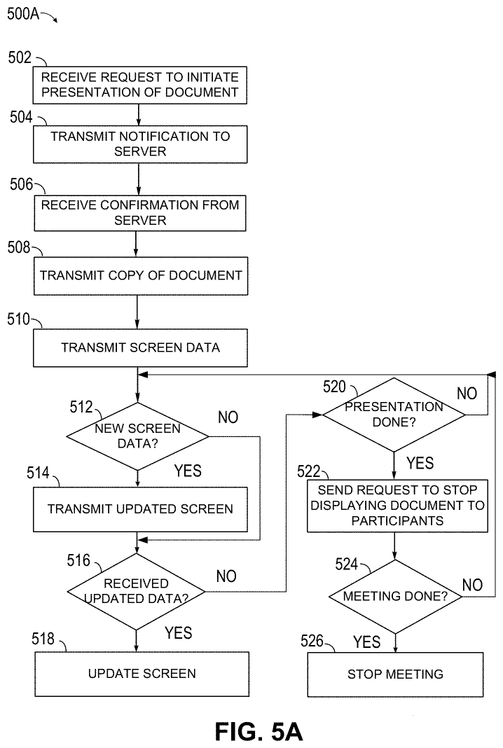

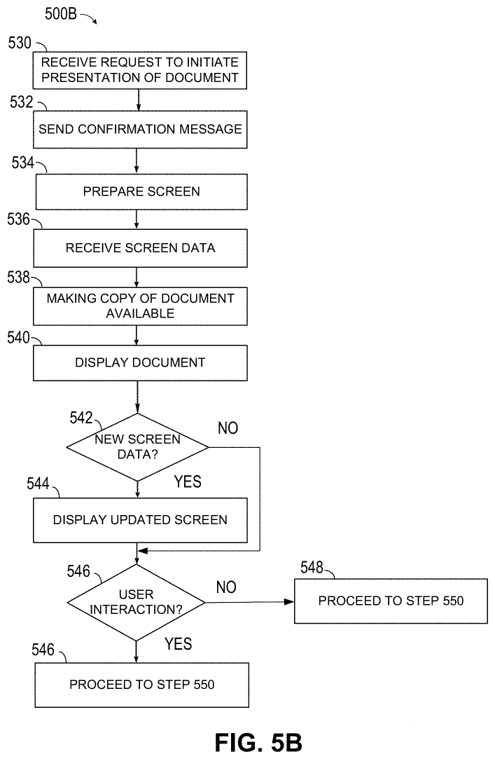

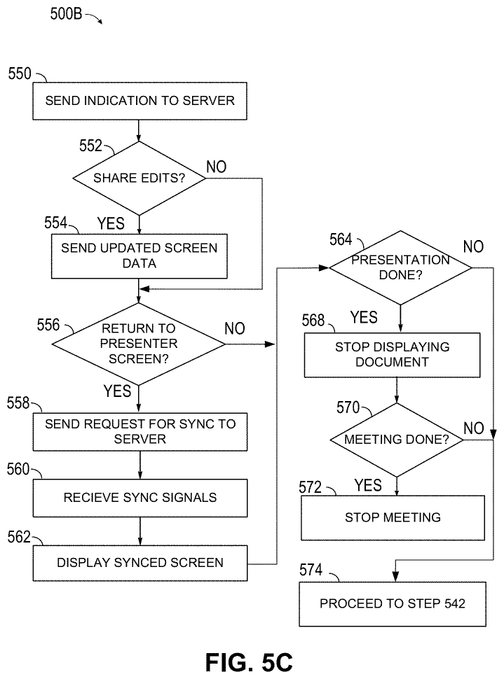

FIG. 5A is a flow diagram depicting an example method 500A, performed by a presenter client device, for enabling meeting participants to interact with content shared by the presenter during a virtual meeting. At 502, method 500A may begin by receiving a request from the user of a virtual meeting application or online service on the client device to initiate presentation of a document during a virtual meeting. This may occur, for example, when the user presses a start presentation button on their screen and chooses a file to present at the meeting. Upon receiving the request, the presenter client device may send a notification to the server to indicate the beginning of a presentation, at 504. In response, the presenter client device, may receive a confirmation message from the server, at 506. Alternatively, the presenter client device may simply begin transmitting data which may include a notification to the server that presentation has started. In either scenario, the presenter client device may transmit a copy of the document being presented, at 508. This may occur automatically, for example, via the virtual meeting application of the presenter or may involve receiving a request for the document from the server first. Alternative, in cases where the document is stored in a data store such as a data store connected to the server, the presenter client device may simply send a pointer to the document to inform the server which document it should use for the presentation. Once the document (or a pointer to it) is sent, method 500A may begin transmitting screen data relating to the presentation, which may include image data showing the presenter's screen, to the server, at 508.

After the document and screen data are sent, method 500A may proceed to determine if any new screen data relating to the presentation is detected, at 512. This may be done via a detecting mechanism as discussed above.

When new screen data is detected, method 500A may proceed to transmit the new updated screen data from the presenter's client device to the server, at 514. If, however, no updated screen data is detected or after the updated screen data is transmitted, method 500A may proceed to determine if any updated screen data has been received, at 516. This may include receiving updated screen data from the other participant's asynchronously activities with the document. In one implementation, the updated screen data may include receiving an updated version of the document which may replace the original version within the context of the virtual meeting application. Alternatively, the updated screen data may include updated portions of the document which may replace portions of the original document within the context of the virtual meeting application.

When it is determined, at 516, that updated screen data has been received from one or more other meeting participants, method 500A may proceed to update the screen of the presenter with the updated screen data, at 518, in a similar manner as screens of the participants are updated with the presenter's information. If, however, it is determined, at 516, that updated screen data has not been received, method 500A may proceed to determine, at 520, if the presentation is complete. This may occur, for example, by the user closing the document. In one implementation, the presenter's client device may make this determination by examining the updated screen data and identifying that the document is no longer part of the screen. This may require comparing the updated screen data with the content of the document.

When method 500A determines that the presentation has been completed, the presenter's client device may proceed to send a request to the server to stop displaying the document each participating device, at 522. When, however, it is determined that the presentation is still ongoing, method 500A may return to step 512 to determine if any new updated screen data has been detected on the presenter's screen and continue with steps of method 500A as discussed above.

After sending a request to stop displaying the document, method 500A may proceed to determine if the meeting has been completed, at 524. This may occur by receiving an indication from the server that the meeting is over, for example when a device identified as the host of the meeting closes the meeting. When it is determined that the meeting is finished, then the virtual meeting application or service may close the screen relating to the meeting, at 526.

When it is determined, at 524, that the meeting is still ongoing, then method 500A may continue return to step 512 to determine if any new updated screen data has been detected on the presenter's screen and continue with steps of method 500A, as discussed above.

FIGS. 5B-5C depict a flow diagram illustrating an example method 500B, performed by a participant client device, for enabling the meeting participant to interact with content shared by a presenter during a virtual meeting. At 530, method 500B may begin by receiving a request from a server to initiate presentation of a document during a virtual meeting. This may occur, for example, when the presenter presses a start presentation button on their screen and chooses a file to present at the meeting and their device sends a request to the server to begin initiating the presentation. The server in turn may forward the request to initiate presentation of the document to the participating device. Upon receiving the request, the participating client device may send a confirmation message to the server, at 532, to indicate the client device's readiness to begin receiving the presentation. Alternatively, the participant client device may simply begin preparing the screen for receiving the presentation, at 534. This may be done by for example moving elements of the user interface around to provide space for the presentation.

Once the participating client device has prepared the screen, method 500B may proceed to receive screen data from the server, at 536, which may have been received by the server from the presenter's client device. In addition to receiving screen data which may include image data showing the presenter's screen, the participant may also receive a copy of the document being presented, at 538. This may occur automatically, for example, via the virtual meeting application of the participant client device or may involve sending a request for the document. The copy received by the participant client device may be an encrypted copy of the document to ensure limited access to the document will be available at the participant device. For example, by encrypting the document and sending the encryption key via the virtual meeting application, the method may ensure that the document cannot be opened outside of the virtual meeting application or online service. In an implementation using a virtual meeting application service, instead of the copy of the document being sent to the participant client device, the copy may be made available at the participant client device via the virtual meeting application service (e.g., via an online browser enabling the virtual meeting application service).

Once the document, its encryption key and the screen data are received, the participant client device may display an interactive version of the document on the screen, at 540. The interactive version may simply be a version of the document with which a user can interact. This may enable the user to both view the presenter's screen and interact with the document, when desired, as discussed above. Once the document is displayed to the participant, method 500A may proceed to determine if any new screen data relating to the presentation has been received, at 542. This may occur when the presenter moves through the document and/or makes any other changes to his shared screen. This may also include receiving updated screen data from the other participant's asynchronously activities with the document. In one implementation, the updated screen data may include receiving an updated version of the document which may replace the original version within the context of the virtual meeting application. Alternatively, the updated screen data may include updated portions of the document which may replace portions of the original document within the context of the virtual meeting application.

When new screen data is detected as being received, method 500B may proceed to update the participant's screen with the updated data, at 544. If, however, no updated screen data has been received or after the updated screen data is displayed, method 500B may proceed to determine if any user interaction with the document has been detected, at 546. The user interaction may include any actions by the user to directly interact with the document (e.g., scrolling through the document or making any edits).

When it is determined, at 546, that user interaction has not taken place, method 500B may proceed to step 550, at 548. If, however, it is determined, at 546, that user interaction has occurred, method 500B may proceed to step 550, at 548. Turning to FIG. 5C, after determining that the user has started interacting with the document, method 500B may proceed to send an indication to the server to notify the server that the user has begun interacting asynchronously with the document, at 550. The notification may include timing information or other data (e.g., screen data) about the point at which the user began interacting with the document. This information may be useful when/if synchronization with the presenter's screen may be needed. In response to the indication, the server may discontinue transmitting updated screen data to the participant's device until such time a request for synchronization is received. Alternatively, the participant device may simply store timing and/or scree data information relating to the point at which user interaction began such that when the user desires to return to the presenter's screen, the participant device is able to synchronize the screens. In this implementation, the participant device may continue receiving updated screen data from the server but may simply store the data instead of updating the screen.

Once the indication has been sent to the server, method 500B may proceed to determine, at 552, if a request to share the user's interactions with the document has been received. This may occur for example via the user selecting a menu button to indicate their desire to share an edit (e.g., a comment, highlighting, etc.) they have made to the document. When it is determined that the user desires to share their interactions with one or more other participants and/or the presenter, the participant device may send updated screen data from the participant's screen to the server, at 544. In one implementation, the updated screen data may include a revised copy of the document which contains the changes made by the participant. In another implementation, the updated screen data may include revised portions of the document. This may be done so that the server can receive the revised document or updated portions and send those to other devices.

When it is determined, at 552, that no desire to share the interactions/edits has been received or after sending the updated screen data to the server, method 500B may proceed to determine, at 556, if a request to return to the presenter's screen has been received. This may occur by for example receiving an indication from the user that they have pressed a return button on the screen to indicate their desire to go back to the presenter's screen. In a split screen design (e.g., when the presenter screen is shown alongside the participant screen), receiving an indication from the user may be implemented by the user simply clicking on the presenter screen. If it is determined that the user desires to return to the presenter's screen, a request may be sent to the server, at 558, for receiving the required synchronization signals for synching the participant's screen with the presenter's screen. In the implementation, in which the synchronization is provided by the participant device, instead of sending a request to the server, the participant device may perform the comparisons required to determine the changes made to the screen while the participant was interacting with the document asynchronously and generate the updated screen data needed for synchronizing the screen.

In the split screen implementation, where both screens are displayed on the same UI, steps 550, 558 and 560 may not need be performed. Instead, the participant device may continue receiving updated screen data from the server through which the presenter screen may continue to be displayed at the same time as the participant view screen on the participant's UI. In such an implementation, synchronization signals may simply include updated screen data for updating the presenter screen as changes are made by the presenter. Invoking a return to presenter's screen option, at 556, in this instant may simply result in the participant only screen disappearing and make space for an enlarged presenter's screen.

After sending a request for synchronization signal, method 500B may receive the required synchronization signals, at 560, before proceeding to display the synchronized screen (e.g., the presenter's current screen), at 562. When it is determined, at 556, that no request to return to the presenter's screen has been received or after the synchronized screen is displayed, method 500B may proceed to determine, at 564, if the presentation is complete. This may occur, for example, by the receiving an indication from the presenter's device that the presenter has closed the document. In one implementation, the presenter's client device may make this determination by examining the updated screen data and identifying that the document is no longer part of the screen. Once method 500B determines that the presentation has been completed, the participant's client device may stop displaying the document, at 568. This may occur by for example moving elements of the UI around to return to the screen before the presentation began.

After the document stops being displayed, method 500B may proceed to determine if the meeting has been completed, at 570. This may occur by receiving an indication from the server that the meeting is over, for example when a device identified as the host of the meeting closes the meeting. When it is determined that the meeting is finished, then method 500B may close the screen relating to the meeting, at 572, to stop the meeting.

When it is determined, at 564, that the presentation is still occurring or that the meeting is still ongoing, at 570, then method 500AB may proceed to step 572 to proceed to step 542 to determine if any new updated screen data has been received and continue with steps of method 500B, as discussed above.

Thus, in different implementations, an improved method and system may be provided to enable a meeting participant to interact with content shared by a presenter during a virtual meeting. In one implementation, a presenter client device may transmit a copy of a document being presented by one of the meeting attendees to all other meeting attendees to enable them to interact asynchronously with the document during the presentation. This may include moving through the document and/or make some changes to the document separate from the presenter. During the presentation, the presenter device may continue to send updated screen data to the sever, but the server may stop transmitting the data to the participant device as long as the participant is interacting synchronously with the document. The updated screen data may then be forwarded by the server to each meeting attendee when they indicate a desire to return to the same screen as the presenter. Thus, participants in a meeting can interact with a document being presented during the meeting as needed in an efficient manner that both saves time and protects the security of the document but will have the ability to return back to the presenter's screen when desired.

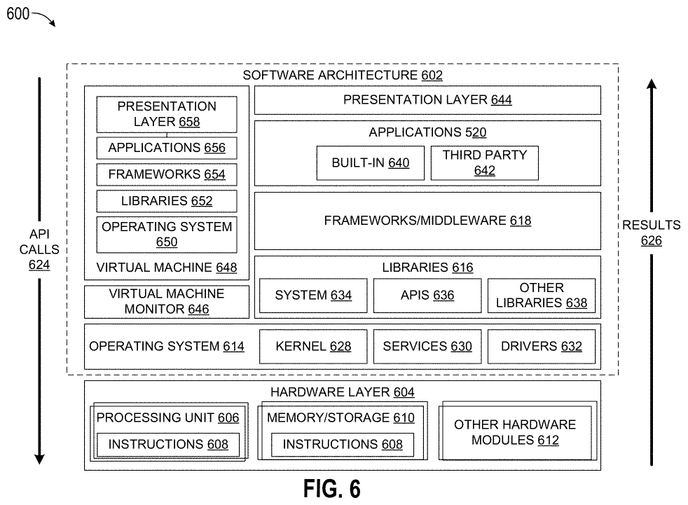

FIG. 6 is a block diagram 600 illustrating an example software architecture 602, various portions of which may be used in conjunction with various hardware architectures herein described, which may implement any of the above-described features. FIG. 6 is a non-limiting example of a software architecture and it will be appreciated that many other architectures may be implemented to facilitate the functionality described herein. The software architecture 602 may execute on hardware such as client devices, native application provider, web servers, server clusters, external services, and other servers. A representative hardware layer 604 includes a processing unit 606 and associated executable instructions 608. The executable instructions 608 represent executable instructions of the software architecture 602, including implementation of the methods, modules and so forth described herein.

The hardware layer 604 also includes a memory/storage 610, which also includes the executable instructions 608 and accompanying data. The hardware layer 604 may also include other hardware modules 612. Instructions 608 held by processing unit 608 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 624. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 620 and/or third-party applications 622. Examples of built-in applications 620 may include, but are not limited to, a contacts application, a browser application, a location application, a media application, a messaging application, and/or a game application. Third-party applications 622 may include any applications developed by an entity other than the vendor of the particular system. The applications 620 may use functions available via OS 614, libraries 616, frameworks 618, and presentation layer 624 to create user interfaces to interact with users.

Some software architectures use virtual machines, as illustrated by a virtual machine 628. The virtual machine 628 provides an execution environment where applications/modules can execute as if they were executing on a hardware machine (such as the machine 600 of FIG. 6, for example). The virtual machine 628 may be hosted by a host OS (for example, OS 614) or hypervisor, and may have a virtual machine monitor 626 which manages operation of the virtual machine 628 and interoperation with the host operating system. A software architecture, which may be different from software architecture 602 outside of the virtual machine, executes within the virtual machine 628 such as an OS 650, libraries 652, frameworks 654, applications 656, and/or a presentation layer 658.

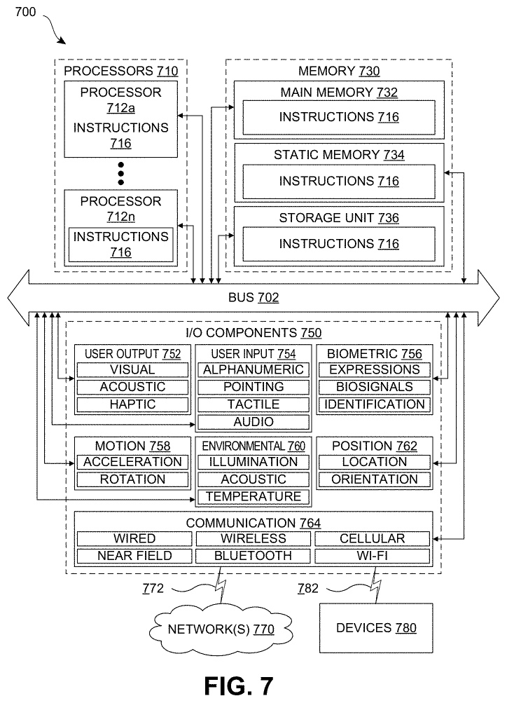

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement methods or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756 and/or position components 762, among a wide array of other environmental sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 762, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-5) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

1. A device comprising:
a processor; and
a memory in communication with the processor, the memory storing executable instructions that, when executed by the processor, cause the device to perform functions of:
receiving a request from a server to initiate presentation of content being presented by a presenter client device during a virtual meeting;
displaying a single copy of the content at the device;
receiving an indication that a meeting participant using the device has initiated interaction with the single copy of content during the virtual meeting by moving to a first portion of the single copy of content different from a second portion of the single copy of content being currently presented by the presenter client device during the virtual meeting;
in response to receiving the indication, displaying the first portion of the single copy of content at the device;
receiving a request at the device to synchronize with the content being presented by the presenter client device; and
in response to receiving the request at the device, displaying the second portion of the single copy of content at the device.

2-4. (canceled)

5. The device of claim 1, wherein moving to the first portion of the single copy of content different from the second portion of the single copy of content being currently presented by the presenter client device comprises scrolling to a page of the of the single copy of content different from a current page being presented by the presenter client device.

6. The device of claim 1, wherein the executable instructions, when executed by the processor, further cause the device to perform functions of receiving a synchronization signal is received from the server.

7. The device of claim 1, wherein the executable instructions, when executed by the processor, further cause the device to perform functions of:
receiving a user input to share edits to the single copy of content made by the meeting participant with other participants of the virtual meeting, when a change is made to the single copy of content at the device; and
transmitting the edits from the device to the server.

8. A method for enabling interactions with content being presented during a virtual meeting, comprising:
receiving a request from a server to initiate presentation of the content being presented by a presenter client device;
displaying a single copy of the content at a participant client device;
receiving an indication that a meeting participant using the participant client device has initiated interaction with the single copy of content during the virtual meeting by moving to a first portion of the single copy of content different from a second portion of the single copy of content being currently presented by the presenter client device during the virtual meeting;
in response to receiving the indication, displaying the first portion of the single copy of content at the participant client device;
receiving a request at the participant client device to synchronize with the content being presented by the presenter client device; and
in response to receiving the request at the participant client device,
displaying the second portion of the single copy of content at the participant client device.

9-11. (canceled)

12. The method of claim 8, wherein moving to the first portion of the single copy of content different from the second portion of the single copy of content being currently presented by the presenter client device comprises scrolling to a page of the single copy of content different from a current page being presented by the presenter client device.

13. The method of claim 8, further comprising receiving a synchronization signal from the server.

14. The method of claim 8 further comprising:
receiving a user input to share edits to the single copy of content made by the meeting participant with other participants of the virtual meeting, when a change is made to the single copy of content at the participant client device; and
transmitting the edits from the participant client device to the server.

15. A non-transitory computer readable medium on which are stored instructions that, when executed, cause a programmable device to:
receive a request from a server to initiate presentation of content being presented by a presenter client device during a virtual meeting;
display a single copy of the content at a participant client device;
receiving an indication that a meeting participant using the participant client device has initiated interaction with the single copy of content during the virtual meeting by moving to a first portion of the document single copy of content different from a second portion of the single copy of content being currently presented by the presenter client device during the virtual meeting;
in response to receiving the indication, displaying the first portion of the single copy of content at the device;
receive a request at the participant client device to synchronize with the content being presented by the presenter client device; and
in response to receiving the request at the participant client device, display the second portion of the single copy of content at the participant client device.

16-18. (canceled)

19. The non-transitory computer readable medium of claim 15, further comprising receiving a synchronization signal from the server.

20. The non-transitory computer readable medium of claim 15, wherein the instructions, further cause the programmable device to:
receive a user input to share edits to the single copy of content made by the meeting participant with other participants of the virtual meeting, when a change is made to the single copy of content at the participant client device; and
transmit the edits from the participant client device to the server.

21. The device of claim 1, wherein:
the single copy of content resides on the device, and
the memory further stores executable instructions that, when executed by the processor, cause the device to perform functions of:
tracking a screen signal received from the server representing a state of the content being presented by the presenter client device; and
in response to receiving the request to synchronize at the device, causing a change from displaying the first portion of the single copy of content at the device to the second portion of the single copy of content being presented by the presenter client device based on the tracked screen signal.

22. The device of claim 1, wherein:
the single copy of content resides on the server,
displaying the single copy of content at the device includes presenting the single copy of content remotely via an online service, and
the memory further stores executable instructions that, when executed by the processor, cause the device to perform functions of:
transmitting a first signal relating to the meeting participant's interaction with the single copy of content to the online service;
in response to transmitting the first signal, receiving display data from the online service corresponding to the first signal;
displaying the first portion of the single copy of content based on the received display data received from the online service,
in response to receiving the request to synchronize at the device, transmitting a second signal to the server to request synchronization,
in response to transmitting the second signal to the server, receiving updated display data for displaying the second portion of the single copy of content via the online service; and
displaying the second portion of the single copy of content based on the updated display data received from the online service.

23. The method of claim 8, wherein the single copy of content resides on the participant client device, the method further comprising:
tracking a screen signal received from the server representing a state of the content being presented by the presenter client device; and
in response to receiving the request to synchronize at the participant client device, causing a change from displaying the first portion of the single copy of content at the participant client device to the second portion of the single copy of content being presented by the presenter client device based on the tracked screen signal.

24. The method of claim 8, wherein:
the single copy of content resides on the server, and
displaying the single copy of content at the participant client device includes presenting the single copy of content remotely via an online service,
the method further comprising:
transmitting a first signal relating to the meeting participant's interaction with the single copy of content to the online service;
in response to transmitting the first signal, receiving display data from the online service corresponding to the first signal;
displaying the first portion of the single copy of content based on the received display data received from the online service,
in response to receiving the request to synchronize at the participant client device, transmitting a second signal to the server to request synchronization,
in response to transmitting the second signal to the server, receiving updated display data for displaying the second portion of the single copy of content via the online service; and
displaying the second portion of the single copy of content based on the updated display data received from the online service.

25. The non-transitory computer readable medium of claim 15, wherein:
the single copy of content resides on the participant client device, and
the instructions, further cause the programmable device to:
track a screen signal received from the server representing a state of the content being presented by the presenter client device; and
in response to receiving the request to synchronize at the participant client device, cause a change from displaying the first portion of the single copy of content at the participant client device to the second portion of the single copy of content being presented by the presenter client device based on the tracked screen signal.

26. The non-transitory computer readable medium of claim 15, wherein:
the single copy of content resides on the server,
displaying the single copy of content at the device includes presenting the single copy of content remotely via an online service, and
the instructions, further cause the programmable device to:
transmit a first signal relating to the meeting participant's interaction with the single copy of content to the online service;
in response to transmitting the first signal, receive display data from the online service corresponding to the first signal;
display the first portion of the single copy of content based on the received display data received from the online service,
in response to receiving the request to synchronize at the device, transmit a second signal to the server to request synchronization,
in response to transmitting the second signal to the server, receive updated display data for displaying the second portion of the single copy of content via the online service; and
display the second portion of the single copy of content based on the updated display data received from the online service

27. A device comprising:
a processor; and
a memory in communication with the processor, the memory storing executable instructions that, when executed by the processor, cause the device to perform functions of:
displaying content presented by a presenter client device during a virtual meeting;
receiving an indication that a meeting participant using the device has initiated interaction with the displayed content during the virtual meeting;
transmitting a first signal relating to the meeting participant's interaction with the content to a server hosting the content;
in response to transmitting the first signal, receiving display data from the server;
displaying a first portion of the content via an online service based on the display data received from the server, the first portion being different from a second portion of content being currently presented by the presenter client device during the virtual meeting;
subsequent to displaying the first portion of the content, receiving a request at the device to synchronize with the content being presented by the presenter client device;
in response to receiving the request to synchronize at the device, transmitting a second signal to the server to request synchronization;
in response to transmitting the second signal to the server, receiving updated display data for displaying the second portion of the content via the online service; and
displaying the second portion of the content based on the updated display data received from the online service.
